(19) United States
(12) Patent Application Publication
(10) Pub. No.: US 2015/0175388 A1
(43) Pub. Date: Jun. 25, 2015

(54) System and Method For Assembling An Elevator Cab

(71) Applicant: ThyssenKrupp Elevator Corporation, Atlanta, GA (US)

(72) Inventor: Michael Klappholz, Hernando, MS (US)

(73) Assignee: ThyssenKrupp Elevator Corporation, Atlanta, GA (US)

(21) Appl. No.: 14/136,343

(22) Filed: Dec. 20, 2013

(51) Int. Cl. B66B 11/02

(52) U.S. Cl. CPC B66B 11/0226; B66B 11/0253

(57) ABSTRACT

An elevator cab generally comprises a platform and a series of wall panels that make up the cab walls. A fastening assembly, used to connect the wall panels with the platform, comprises a stud and a retainer clip. The stud is connected to the wall panels and the retainer clip is connected with the platform. Furthermore, the stud and retainer clip engage without the use of tools in a manner that securely fastens the wall panels to the platform to thereby construct portions of the elevator cab.

### BACKGROUND

An elevator cab, also referred to as an elevator car, generally comprises a platform, a ceiling and a series of wall panels that make up the cab walls. The wall panels are typically fastened to the platform by means of screws and/or bolts using the appropriate tools. While a variety of techniques for assembling components of an elevator cab have been made and used, it is believed that no one prior to the inventors has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings. In the drawings like reference numerals identify the same elements.

FIG. 1 depicts a perspective view of an exemplary elevator car incorporating a fastening assembly showing the elevator car partially assembled.

FIG. 2 depicts a perspective view of the exemplary fastening assembly of FIG. 1.

FIG. 3A depicts a perspective view of an exemplary stud of the fastening assembly.

FIG. 3B depicts a perspective view of another exemplary stud of the fastening assembly.

FIG. 3C depicts a perspective view of another exemplary stud of the fastening assembly.

FIG. 4A depicts top view of an exemplary retainer clip of the fastening assembly.

FIG. 4B depicts top view of another exemplary retainer clip of the fastening assembly.

FIG. 4C depicts top view of another exemplary retainer clip of the fastening assembly.

FIG. 4D depicts a top view of an alternate exemplary retainer clip of the fastening assembly.

FIG. 4E depicts a top view of an alternate exemplary retainer clip of the fastening assembly.

FIG. 5 depicts a cross-sectional view of the fastening assembly with the stud engaging the retainer clip.

The drawings are not intended to be limiting in any way, and it is contemplated that different versions may be carried out in other ways, including those not necessarily depicted in the drawings. The accompanying drawings illustrate several aspects of the present invention, and with the description serve to explain the principles of the invention. The present invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description. As will be realized, the invention is capable of other different and obvious aspects, all without departing from the invention. Accordingly, the drawings and descriptions should be regarded as illustrative in nature and not restrictive.

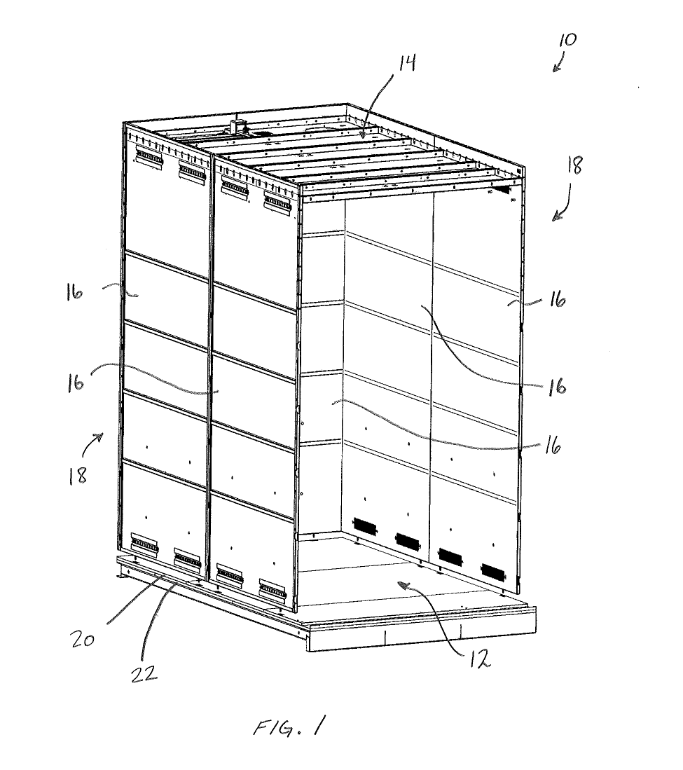

FIG. 1 illustrates an exemplary elevator car (10), also referred to as an elevator cab, shown without elevator doors installed. Elevator cab (10) includes a platform (12), ceiling (14), and a series of wall panels (16) that make up the cab walls (18). Although elevator cab (10) is shown in a generally rectangular shape, it should be understood that the shape of elevator cab (10) may be of any suitable shape. Similarly, wall panels (16) are shown with a certain shape and size relative to platform (12). However, it should be understood that wall panels (16) may be of any suitable size or shape.

Platform (12) is of a generally planar rectangular shape suitable to serve as the base or floor of elevator cab (10), however, various functional and/or decorative floor coverings can be used to cover platform (12). Platform (12) is not limited to a generally planar rectangular shape as platform (12) may have other shapes or form suitable for the base or floor of elevator cab (10). Platform (12) can comprise one or more layers of plywood or steel. In the present example, platform (12) comprises two layers, a plywood sub-floor (20) on top and a metal sub-floor or frame beneath (22). Platform (12) also comprises a plurality of mounting holes (24) for fastening wall panels (16) thereto to assemble elevator cab (10). Mounting holes (24) extend into plywood sub-floor (20) and in some versions may extend through the plywood sub-floor (20) and into or through metal sub-floor or frame (22). Platform (12) includes any suitable number of mounting holes (24) in any suitable arrangement for attaching walls (18) to platform (12). Platform (12) should not be limited to the arrangement described above as other examples of a suitable platform (12) will be apparent to those of ordinary skill in the art in view of the teachings herein.

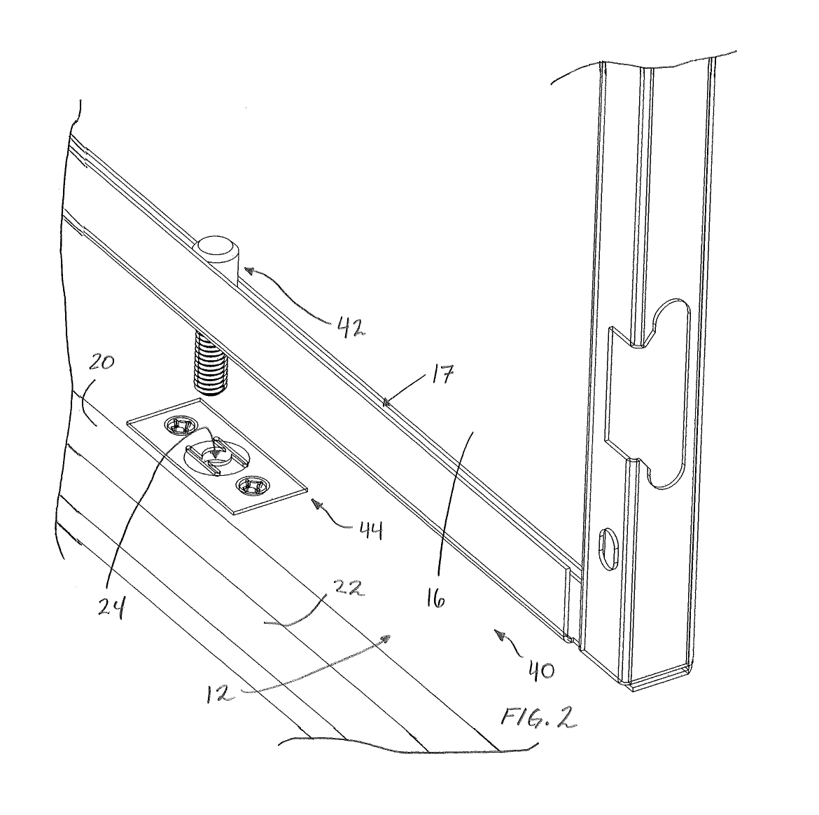

FIG. 2 shows an exemplary fastening assembly (40) used with elevator cab (10). In the present example, wall panel (16) is shown detached from a platform (12). Attached to wall panel (16), within a channel (17) formed as part of wall panel (16), is a stud or rivet (42) oriented downward toward platform (12). Stud (42) is oriented such that it engages a retainer clip (44) when wall panel (16) is attached to platform (12). As shown, retainer clip (44) is positioned above one of mounting holes (24) such that stud (42) can pass through retainer clip (44) and into mounting hole (24). In some instances retainer clip can be considered a female fastener or fastening member while stud (42) can be considered a male fastener or fastening member.

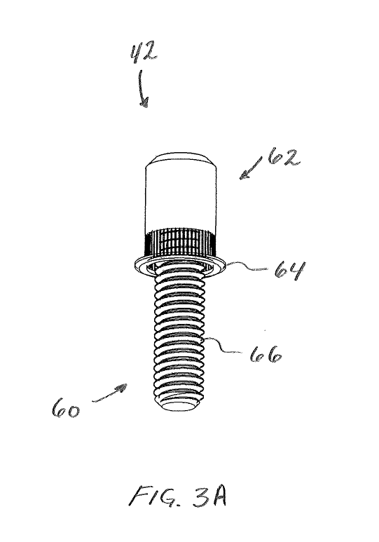

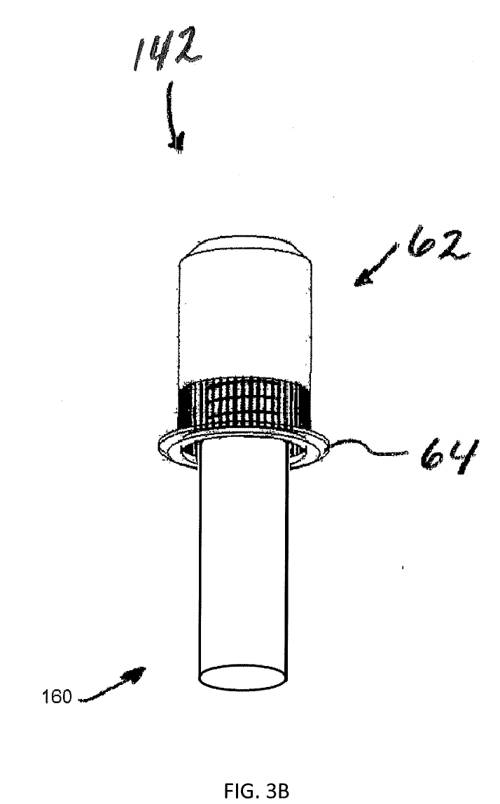

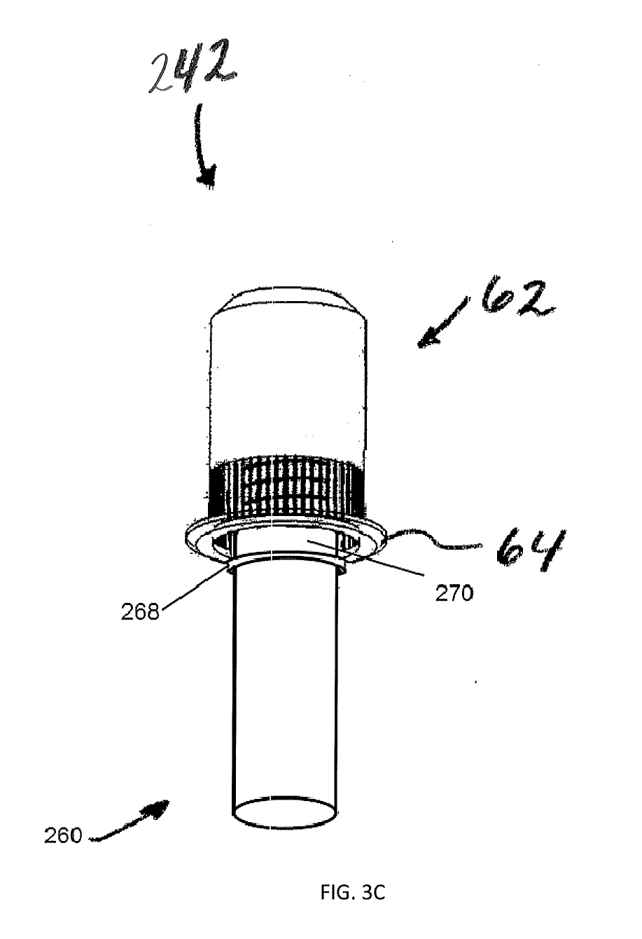

FIG. 3A shows a perspective view of stud (42). As shown, stud (42) has an engaging end (60) and an attachment end (62), separated by a collar (64). Stud (42) is generally cylindrical in shape, but other suitable shapes will be apparent to those of ordinary skill in the art in view of the teachings herein. Engaging end (60) is configured with threads (66) that are configured to engage retainer clip (44). FIG. 3B shows a perspective view of alternate exemplary stud (142) with an alternative engaging end (160). As shown, engaging end (160) is of a substantially smooth and cylindrical shape. Retainer clip (44) frictionally engages the smooth, cylindrical surface of the engaging end (160). FIG. 3C shows a perspective view of another alternative exemplary stud (242) with an alternative engaging end (260). As shown, engaging end (260) is of a substantially smooth and cylindrical shape. An engagement rib (268) circumscribes a portion of engaging end (260) near collar (64). Retainer clip (44) frictionally engages an engagement portion (270) of the engaging end (260) between the collar (64) and engagement rib (268).

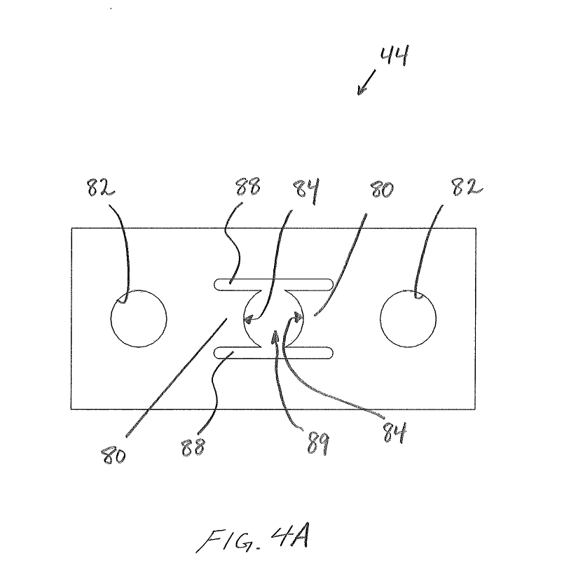

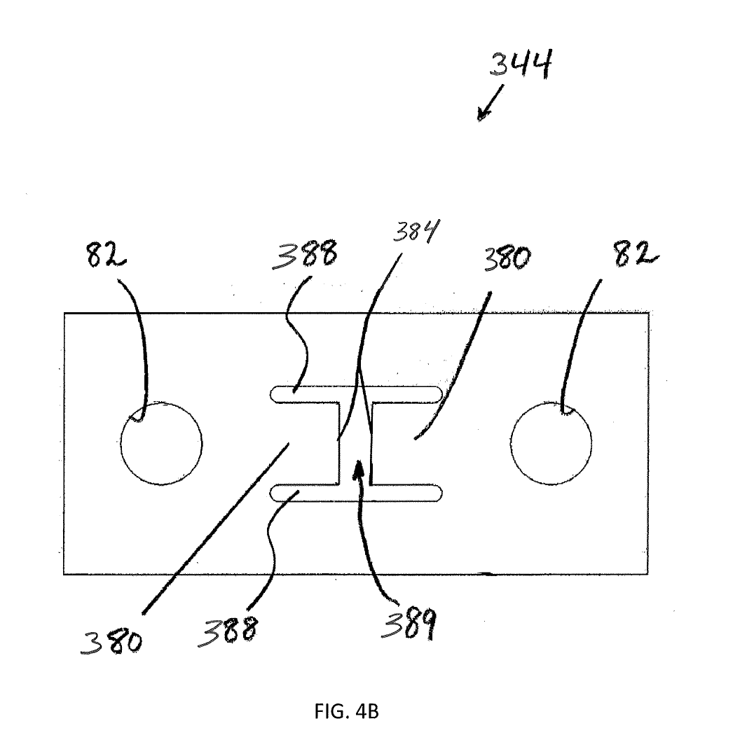

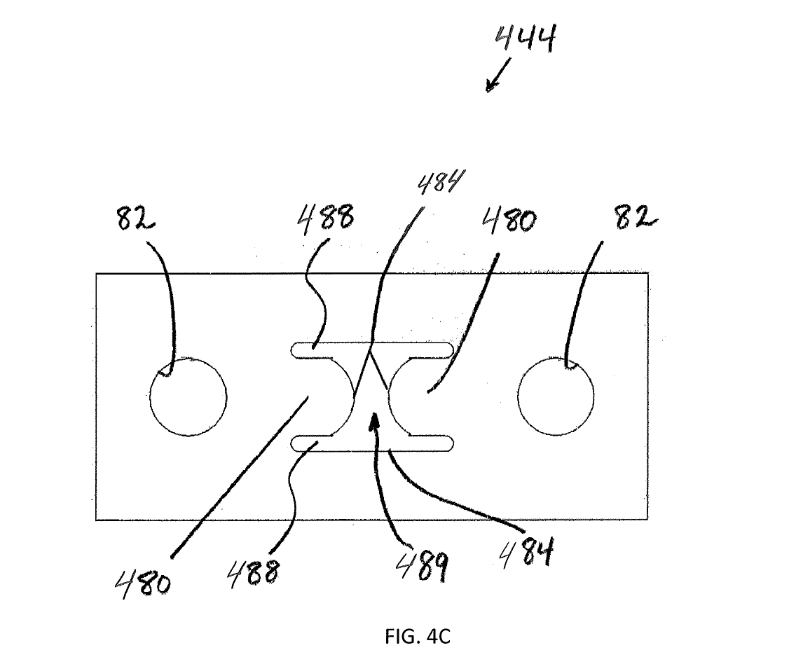

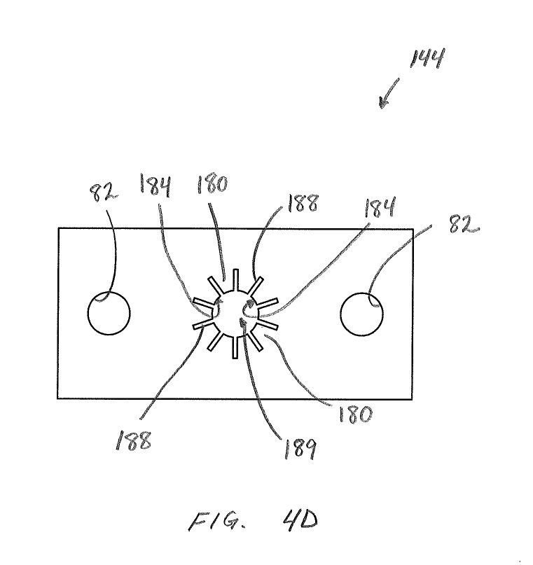

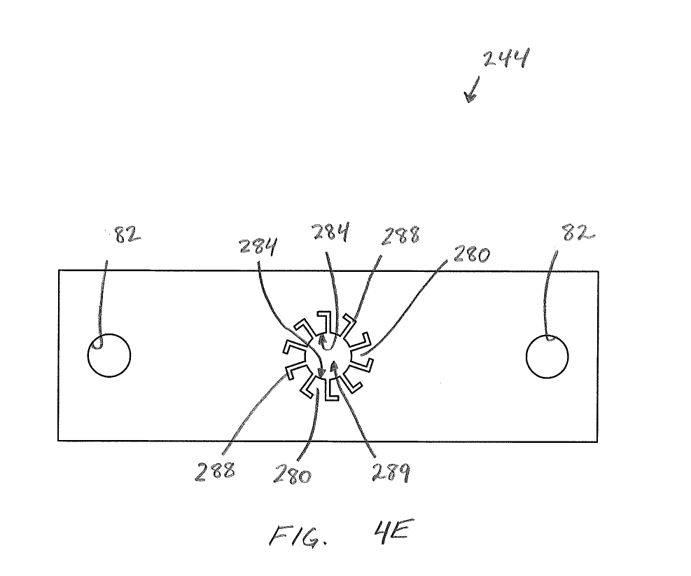

FIG. 4A shows a top view of retainer clip (44). As shown, retainer clip (44) is generally rectangular in shape. However, in some other versions, retainer clip (44) can have other shapes, e.g. circular, square, etc., that will be apparent to those of ordinary skill in the art in view of the teachings herein. Retainer clip (44) comprises at least one retaining member or retaining tab (80), and in the illustrated version of FIG. 4A two retaining members (80). Retainer clip (44) also comprises fastening holes (82). While retainer clip (44) in the present example is comprised of a material such as carbon steel, retainer clip (44) may be comprised of other suitable materials that will be apparent to those of ordinary skill in the art in view of the teachings herein. For example, in some versions retainer clip (44) is comprised of other metallic materials such as carbon steel with alloying additions, nickel copper, copper nickel or aluminum. Yet in still other embodiments, retainer clip (44) may be comprised of plastics such as thermoplastics including, but not limited to, ABS or high density polyethylene (HDPE).

Each retaining member (80) comprises an end (84). In the present example, retaining members (80) are cut into retainer clip (44) such that they define retaining slots (88) and hole or aperture (89). Retaining slots (88) may be of any suitable dimension, as will be described in more detail below. In the present example, stud (42, 142, 242) is received within hole (89) of retaining clip (44). Furthermore, retaining members (80) are configured to engage with engaging end (60, 160, 260) of stud (42, 142, 242) respectively as described in greater detail below.

FIG. 2 depicts stud (42) attached to wall panel (16) within channel (17) formed in wall panel (16). Channel (17) is defined by a lower section of wall panel (16) that is bent twice at about 90 degrees each time to create a partial U-shape in wall panel (16). In the present example, stud (42) is attached to wall (16) by a rivet type fastening. More specifically, wall panel (16) includes a hole through which stud (42) is placed. Force is exerted on stud (42), e.g. by pushing stud (42) from the attachment end (62) or by pulling stud (42) from engaging end (60). In some instances, sufficient force is applied to stud (42) such that attachment end (62) undergoes a deformation where attachment end (62) flattens and increases in diameter creating a mushroom effect against collar (64). This produces a mechanical type connection between stud (42) and wall panel (16) such that stud (42) is securely fastened with wall panel (16). In other embodiments, stud (42) may be attached by a bolt type fastener wherein stud (42) is threaded such that a bolt may be used to attach stud (42) to wall panel (16). Yet in other embodiments, stud (42) may be configured with a through hole allowing fastening to be facilitated through the insertion of one or more pins. Further still, other embodiments may be configured such that wall panel (16) and stud (42) are a part of a unitary design. In the present example, stud (42) is joined with wall panel (16) during wall panel (16) fabrication before wall panels (16) are delivered to an installation site. This facilitates installation of wall panels (16) to platform (12) at the installation site without the use of tools. In some other versions, studs (42) may be joined with wall panels (16) at the installation site. Other suitable structures and ways for attaching stud (42) to wall panel (16) will be apparent to one of ordinary skill in the art from the teachings herein.

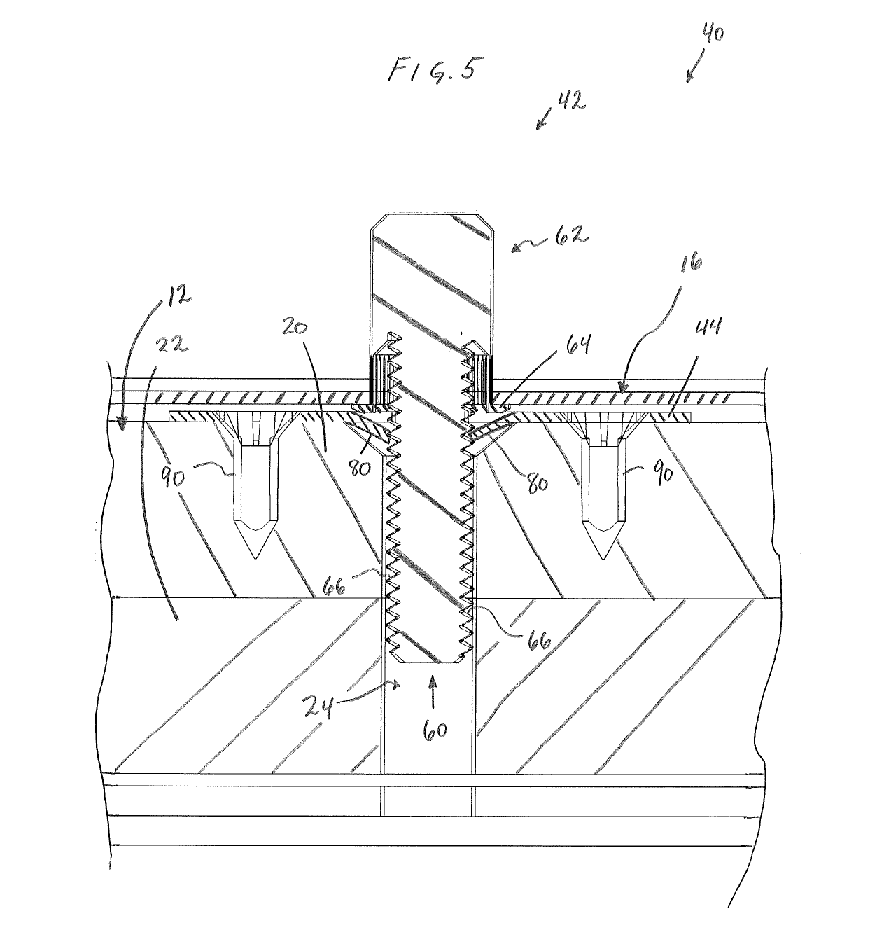

Stud (42) is located along and on wall panel (16) to correspond to a mounting hole (24) location in platform (12). As shown in FIG. 5, platform (12) is configured with a variety of mounting holes (24). In the present example, mounting holes (24) are pre-drilled or pre-punched and configured around the perimeter of platform (12) in locations that generally coincide with stud (42) locations of wall panels (16) that will be located and attached to platform (12). By way of example only, mounting holes (24) may be configured in several clusters making it possible to use different stud (42) configurations with a single platform (12). Yet in still other examples, mounting holes (24) may be limited to the precise stud (42) number and location relative to wall panel (16) placement. Other suitable combinations of mounting hole (24) and stud (42) configurations will be apparent to one of ordinary skill in the art in view of the teachings herein.

As shown in FIG. 5, retainer clip (44) is attached to platform (12) directly above mounting hole (24). In the present example, retainer clip (44) is shown attached to platform (12) by fasteners (90) extending through fastening holes (82) in retainer clip (44). Although not required in all versions, retainer clips (44) can be fastened with platform (12) during the fabrication of platform (12) before platform (12) is delivered to an installation site. Again, this facilitates assembly of elevator cab (10) at the installation site without the use of tools. Fasteners (90) can be screws, nails, rivets, bolts, etc. Although in the present example retainer clip (44) is secured with two fasteners (90)—one located on each end of retainer clip (44)—in other versions greater or fewer fasteners can be used and they can be positioned in any suitable location along retainer clip (44) that will result in retainer clip (44) being securely fastened to platform (12). By way of example only, and not limitation, retainer clip (44) can be configured with two fastening holes (82) on each side, thus allowing use of four fasteners (90). Yet in other embodiments, fasteners (90) may be omitted entirely wherein retainer clip (44) is fastened to platform with an adhesive or weld. In further embodiments, retainer clip (44) may be integrated into platform (12), such that retainer clip (44) and platform (44) are of a unitary design. For instance, in some versions, retainer clip (44) can be formed within platform (12), e.g. by cutting platform (12) with slots (88) and hole (89). In view of the teachings herein, other modifications and ways to connect retainer clip (44) with platform (12) will be apparent to those of ordinary skill in the art.

Retainer clip (44) is shown on the top surface of platform (12). In other embodiments, platform (12) may have a recessed area configured to receive retainer clip (44) such that retainer clip (44) is flush with the top surface of platform (12). Similarly, in some other versions retainer clip (44) is on the top surface of platform (12), and wall panel (16) is configured with a recess along its bottom surface where the recess dimensions are such that the thickness of retainer clip (44) fits within the recess such that wall panel (16) sits flush with platform (12). Still in other versions, retainer clip (44) can be mounted below top surface of platform (12). Other ways of mounting retainer clips (44) to platform (12) and wall panels (16) to platform (12) via connection with retainer clips (44) will be apparent to those of ordinary skill in the art in view of the teachings herein.

FIG. 5 taken together with FIGS. 3A and 4A shows an exemplary configuration of stud (42) and retainer clip (44) engaging to fasten wall panel (16) to platform (12). Retainer clip (44) is configured to receive engaging end (60) of stud (42). Although not required in all versions, in the illustrated example of FIG. 4A, ends (84) of retaining member (80) of retainer clip (44) are generally of a shape which corresponds to the shape of engaging end (60) of stud (42). For instance, in FIG. 4A, ends (84) form a generally semi-circular shape with a curvature configured to match the profile of engaging end (60) to provide a tight interference fit between ends (84) and stud (42). In an alternative embodiment seen in FIG. 4B, ends (384) of retainer clip (344) are generally straight or linear. In another embodiment seen in FIG. 4C, ends (484) of retainer clip (444) form a generally semi-circular shape with an opposite curvature to the profile of engaging ends (60, 160, 260). It should be understood that any of the retainer clips (44, 144, 244, 344, 444) described can be used with any of the studs (42, 142, 242) described.

When stud (42), with engaging end (60), is inserted into retainer clip (44), retention members (80) resiliently engage threads (66) located on stud (42), thus retention members (80) are resilient. Said resilient engagement holds stud (42) in place within mounting hole (24) when stud (42) is inserted into retainer clip (44) so that stud (42) resists removal. When stud (142), with engaging end (160), is inserted into retainer clip (44), retention members (80) resiliently engage the smooth, cylindrical surface of the engaging end (160). Said resilient engagement holds stud (142) in place within mounting hole (24) when stud (142) is inserted into retainer clip (44) so that stud (142) resists removal. When stud (242), with engaging end (260) is inserted into retainer clip (44), retention members (80) allow engagement rib (268) to pass by. Retention members (80) resiliently engage engagement portion (270) between collar (64) and engagement rib (268) of engaging end (260). Said resilient engagement in combination with engagement rib (268) holds stud (242) in place within mounting hole (24) when stud (242) is inserted into retainer clip (44) so that stud (242) resists removal. The configurations described herein are merely exemplary and other embodiments may provide resilient engagement by means of other configurations. By way of example only, in some versions engaging end (60) of stud (42) has a different shape such as hexagonal, or rectangular. In such case, ends (84) could have a shape corresponding to this shape of stud (42), or ends (84) could have a shape that differs from the shape of the stud (42).

The resiliency of retaining members (80) is contributed to by slots (88) in retainer clip (44). In the present example, slots (88) are dimensioned to provide suitable stiffness to retainer clip (44) and suitable resiliency to retaining members (80). As will be apparent to those of ordinary skill in the art in view of the teachings herein, suitable dimensions for slots (88) may vary depending on a variety of elements such as the material of the retainer clip (44), the material of the stud (42), the dimensions of the retainer clip (44), the dimensions of stud (42), etc.

The present example shows two retaining members (80)—one for each side of retainer clip (44). However, it should be understood that additional retaining members (80) may be used. In other embodiments, there may be retaining members (80) on both the longitudinal and transverse portions of retainer clip (44). Yet in other embodiments a plurality of retaining members (80) may be used, oriented circumferentially around stud (42). FIGS. 4B-4E illustrated alternative retainer clip versions that can be used in place retainer clip (44) described above.

FIG. 4B illustrates retainer clip (344) that comprises I-beam shaped cut-out near the center. The I-beam shaped cut-out is defined by slots (388) that connect with central aperture (389) having a rectangular shape. With this configuration, retainer clip (344) comprises retaining members (380) positioned around aperture (389). When retainer clip (344) is used with fastening assembly (40), retaining clip (344) is fastened to platform (12) using screws or similar fasteners, and stud (42, 142, 242), which is connected with wall panel (16) as mentioned above, extends through aperture (389) with retaining members (380) resiliently engaging engaging end (60, 160, 260) of stud (42, 142, 242). With this configuration, engaging end (60, 160, 260) of stud (42, 142, 242), when engaged with retainer clip (344), is generally contacted by ends (384) of retaining members (380).

FIG. 4C illustrates retainer clip (444) that comprises a modified I-beam shaped cut-out near the center. The modified I-beam shaped cut-out is defined by slots (488) that connect with central aperture (489). With this configuration, retainer clip (444) comprises retaining members (480) positioned around aperture (489). When retainer clip (444) is used with fastening assembly (40), retaining clip (444) is fastened to platform (12) using screws or similar fasteners, and stud (42, 142, 242), which is connected with wall panel (16) as mentioned above, extends through aperture (489) with retaining members (480) resiliently engaging engaging end (60, 160, 260) of stud (42, 142, 242). With this configuration, engaging end (60, 160, 260) of stud (42, 142, 242), when engaged with retainer clip (444), is generally contacted by ends (484) of retaining members (480).

FIG. 4D illustrates retainer clip (144) that comprises star-shaped cut-out near the center. The star-shaped cut-out is defined by slots (188) that are configured in a radial pattern and extend from a central hole (189). With this configuration, retainer clip (144) comprises a plurality of retaining members (180) positioned around hole (189). When retainer clip (144) is used with fastening assembly (40), retaining clip (144) is fastened to platform (12) using screws or similar fasteners, and stud (42, 142, 242), which is connected with wall panel (16) as mentioned above, extends through hole (189) with retaining members (180) resiliently engaging engaging end (60, 160, 260) of stud (42, 142, 242). With this configuration, engaging end (60, 160, 260) of stud (42, 142, 242), when engaged with retainer clip (144), is generally circumferentially surrounded by and contacted by ends (184) of retaining members (180).

FIG. 4E illustrates retainer clip (244) that comprises a radial cut-out near the center. The radial cut-out is defined by slots (288) that are configured in a radial pattern and extend from a central hole (289). Slots (288) further extend outward from center of hole (289) and then turn at an angle. By way of example only, and not limitation, in the illustrated version of FIG. 4E the angle is approximately ninety degrees. In other version the angle may be exactly, greater, or less than ninety degrees. In the illustrated configuration, slots (288) can be considered to have an L-shape and are circumferentially positioned around hole (289). When retainer clip (244) is used with fastening assembly (40), retaining clip (244) is fastened to platform (12) using screws or similar fasteners, and stud (42, 142, 242), which is connected with wall panel (16) as mentioned above, extends through hole (289) with retaining members (280) resiliently engaging engaging end (60, 160, 260) of stud (42, 142, 242). With this configuration, engaging end (60, 160, 260) of stud (42, 142, 242), when engaged with retainer clip (244), is generally circumferentially surrounded by and contacted by ends (284) of retaining members (280).

As mentioned previously, the degree of resiliency of retaining members (80, 180, 280, 380, 480) can be controlled by several factors mentioned above. One such factor that can play a large part in the degree of resiliency imparted to retaining member (80, 180, 280, 380, 480) is the configuration of slots (80, 180, 280, 380, 480). In each of retaining clips (44, 144, 244, 344, 444) slots (80, 180, 280, 380, 480) respectively connect in some way with central holes (89, 189, 289, 389, 489). For example, with retainer clip (44), slots (80) tangentially connect with hole (89) to define retaining members (80). With retainer clips (144, 244), a first end of slots (180, 280) connect with holes (189, 289) respectively such that slots (180, 280) orthogonally connect with holes (189, 289). These different configurations can provide retaining clips with differing degrees of resiliency for retaining members. By way of example only, and not limitation, where retaining members are defined by slots that are closer together, retaining members can have greater resiliency. In view of the teachings herein, other ways to modify or configure retaining clips, and the slots and holes therein, will be apparent to those of ordinary skill in the art.

Another common feature between retaining clips (44, 144, 244, 344, 444) is that retaining members (80, 180, 280, 380, 480), before contacting engaging end (60, 160, 260) of stud (42, 142, 242) and resiliently flexing or bending, have a position that is generally perpendicular to the longitudinal axis defined by stud (42, 142, 242). With this configuration, when retaining members (80, 180, 280, 380, 480) do flex, retaining members (80, 180, 280, 380, 480) are directed downward as shown in FIG. 5. This orientation provides a secure connection between wall panels (16) and platform (12) that resists wall panels (16) separating upwardly from platform (12).

While the above description has shown and described fastening assembly (40) used to attach wall panels (16) to platform (12), fastening assembly (40) can also be used or adapted for use to connect one wall panel (16) with another wall panel (16), and/or to connect wall panels (16) with ceiling (14). In view of the teachings herein, other ways to use fastening assembly (40) and other components described herein will be apparent to those of ordinary skill in the art.

Having shown and described various versions in the present disclosure, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. An elevator car comprising:
(a) a platform comprising a plurality of holes;
(b) at least one wall, wherein the at least one wall connects to the platform;
(c) a male fastening member having an engaging portion; and
(d) a female fastening member comprising
(i) an aperture, wherein the aperture is oriented coaxially to one of the plurality of holes of the platform, and
(ii) a resilient engaging member, wherein the resilient engaging member defines the aperture, wherein the engaging member is configured to resiliently engage the engaging portion of the male fastening member to connect the at least one wall to the platform.

2. The apparatus of claim 1, wherein the female fastening member further comprises a slot, wherein the slot further defines the resilient engaging member.

3. The apparatus of claim 2, wherein the slot is tangentially positioned relative to the aperture.

4. The apparatus of claim 2, wherein the slot is orthogonally positioned relative to the aperture.

5. The apparatus of claim 1, wherein the male fastening member is secured to the at least one wall

6. The apparatus of claim 1, wherein the female fastening member is attached to the platform.

7. The apparatus of claim 1, wherein the plurality of holes are circular.

8. The apparatus of claim 7, wherein the holes are near a perimeter of the platform.

9. The apparatus of claim 1, wherein the male fastening member comprises an attachment portion and a collar, wherein the attachment portion and the collar form an interference fitting between the male fastening member and the at least one wall.

10. The apparatus of claim 1, wherein the engaging portion of the male fastening member is threaded.

11. The apparatus of claim 1, wherein the engaging portion of the male fastening member is generally smooth.

12. The apparatus of claim 1, wherein the engaging member is oriented substantially perpendicular relative to the male fastening member.

13. An elevator car fastening assembly comprising:
(a) a clip, wherein the clip is securely fastened to a platform of the elevator car, the clip comprising:
(i) at least one resilient tab, and
(ii) an aperture, wherein, the aperture is defined by the at least one resilient tab, and wherein the aperture is coaxially aligned with an opening in the platform; and
(b) at least one wall assembly comprising:
(i) a wall portion, and
(ii) a fastening member, having an end, wherein the end is locked in place by the at least one resilient tab when the fastening member is inserted into the aperture of the clip.

14. The apparatus of claim 13, wherein the fastening member further comprises at least one slot, wherein the slot further defines the resilient tab.

15. The apparatus of claim 14, wherein the slot is tangentially positioned relative to the aperture.

16. The apparatus of claim 14, wherein the slot is orthogonally positioned relative to the aperture.

17. The apparatus of claim 13, wherein the at least one wall is connectable to the platform during an installation without the use of tools.

18. The apparatus of claim 13, wherein the end of the fastening member is threaded.

19. The apparatus of claim 13, wherein the end of the fastening member is generally smooth.

20. A method of installing an elevator wall onto an elevator platform comprising:
(a) attaching a fastening member to the elevator wall with an engaging member of the fastening member protruding from the elevator wall;
(b) aligning a clip onto the elevator platform, wherein the clip has an aperture defined by at least two engaging members, wherein the elevator platform has a plurality of openings, wherein the clip is coaxially aligned with at least one of the openings on the elevator platform; and
(c) inserting the engaging member protruding from the wall into the coaxially aligned aperture and opening thereby resiliently locking the elevator wall to the elevator platform.
